(19) United States
(12) Patent Application Publication
(10) Pub. No.: US 2023/0180782 A1
(43) Pub. Date: Jun. 15, 2023

(54) PLANT-BASED MILK WHIPPABLE EMULSION

(71) Applicant: Rich Products Corporation, Buffalo, NY (US)

(72) Inventors: Lorna LiPuma, Kenmore, NY (US); Aida Elizabeth Leyva Gonzalez, West Seneca, NY (US)

(21) Appl. No.: 18/066,086

(22) Filed: Dec. 14, 2022

Related U.S. Application Data
(60) Provisional application No. 63/289,375, filed on Dec. 14, 2021.

(51) Int. Cl. A23D 7/005; A23D 7/04; A23P 30/40; A23D 7/06

(52) U.S. Cl. CPC A23D 7/0053; A23D 7/04; A23P 30/40; A23D 7/06

(57) ABSTRACT

Disclosed herein are plant-based whippable topping emulsions. In particular, described herein are plant-based emulsions that do not contain any of the eight major food allergens. In addition to plant-based products, the emulsions may generally contain vegetable oil and one or more other components such as surfactants, sugar, stabilizers, thickeners, and flavoring. Also disclosed herein are methods of making and methods of using the plant-based milk whippable topping emulsions.

### CROSS-REFERENCE TO RELATED APPLICATIONS

This application claims priority to U.S. Provisional Patent Application No. 63/289,375, filed Dec. 14, 2021, which is incorporated herein by reference in its entirety.

### FIELD

This disclosure relates to plant-based milk whippable emulsions. Described herein are plant milk-based emulsions that do not contain any of the eight major food allergens. In addition to plant-based products, the emulsions may generally contain vegetable oil and one or more other components such as surfactants, sugar, stabilizers, thickeners, and flavoring. Also described herein are methods of making and methods of using the plant-based milk whippable topping emulsions.

### INTRODUCTION

Food hypersensitivities such as allergies and intolerances affect millions of people worldwide. Food allergies occur when the body's immune system reacts to certain proteins in food whereas food intolerances do not involve the immune system and often are a result of an inability to digest a particular food. The Food & Drug Administration (FDA) has identified eight foods as major food allergens: milk, eggs, fish, shellfish, tree nuts, peanuts, wheat, and soybeans. Besides food hypersensitivities, consumers are becoming more health and environmentally conscious and are moving away from food products that contain animal products such as dairy, eggs, fish, and shellfish. In particular, dairy products are the leading source of saturated fat in diets and contribute to chronic diseases such as heart disease and prostate cancer. In addition, animal agriculture used to produce dairy products and eggs lead to climate change via, for example, greenhouse gas emissions and contamination of soil and water.

In view of the foregoing, there is a demand for whippable food products that do not contain major food allergens or dairy. The beneficial health effects of dietary fibers are well known and there has therefore been a growing interest in food products made from cereals, such as oats and oat milk. Oats and oat milk are allergen free, dairy-free, high in fiber, high in vitamins and minerals, low in saturated fats, cholesterol free, and regulators of blood sugar levels. In addition, oat milk has the lowest overall carbon footprint and uses the least amount of water to produce the milk as compared to dairy milk and other non-dairy, allergen-containing milks such as soymilk and almond milk.

Whippable food products are commonly used as toppings, icings, fillings, and the like for food products such as desserts. Consumer selection of whippable products depends upon the feel and taste of the whipped product, and various stability indicators. It is known that substituting dairy products with non-dairy products such as oat milk and nut milks in whippable food products is complex because a 1:1 substitution does not provide the desired organoleptic properties to the whippable food product.

Thus, there is a need for allergen-free and dairy-free whippable food products that taste similar to dairy whippable toppings, have a long shelf life, and have ideal organoleptic properties.

### SUMMARY

In an aspect, the disclosure relates to a whippable topping emulsion comprising: (a) plant-based milk; (b) vegetable oil; (c) surfactant; (d) thickener; (e) stabilizer; and, (f) one or more other components comprising sweeteners and flavoring agents.

In a further aspect, the disclosure relates to a whippable topping emulsion comprising: (a) from about 10 wt % to about 50 wt % plant-based milk; (b) from about 10 wt % to about 35 wt % vegetable oil; (c) from about 0.05 wt % to about 0.55 wt % surfactant; (d) from about 0.02 wt % to about 5.0 wt % thickener; (e) from about 0.02 wt % to about 5.0 wt % stabilizer; and, (f) one or more other components comprising sweeteners and flavoring agents.

Another aspect of the disclosure provides a whippable topping emulsion comprising: (a) oat milk; (b) vegetable oil; (c) surfactant; (d) thickener; (e) stabilizer; and, (f) one or more other components comprising sweeteners and flavoring agents.

Another aspect of the disclosure provides a whippable topping emulsion comprising: (a) from about 10 wt % to about 50 wt % oat milk; (b) from about 10 wt % to about 35 wt % vegetable oil; (c) from about 0.05 wt % to about 0.55 wt % surfactant; (d) from about 0.02 wt % to about 5.0 wt % thickener; (e) from about 0.02 wt % to about 5.0 wt % stabilizer; and, (f) one or more other components comprising sweeteners and flavoring agents. In an embodiment, the vegetable oil comprises palm kernel oil, coconut oil, palm oil, cottonseed oil, soy oil, or a combination thereof. In another embodiment, the surfactant is an emulsifier comprising a hydrophilic-lipophilic balance (HLB) value greater than 9. In another embodiment, the thickener comprises gellan gum, carobean gum, locus bean gum, cellulose gum, alginate gum, agar, guar gum, xanthan gum, gum arabic, sodium carboxymethyl cellulose, or a combination thereof. In another embodiment, the stabilizer comprises cellulose gum, gellan gum, native starches, modified starches, fibers, flours, sodium citrate, or a combination thereof. In another embodiment, the whippable topping emulsion comprises from about 1 wt % to about 30 wt % sweetener. In another embodiment, the sweetener comprises sugar, rice syrup, corn syrup, high fructose corn syrup, tapioca syrup, dextrose, or a combination thereof. In another embodiment, the whippable topping emulsion comprises from about 0.05 wt % to about 3 wt % of a flavoring agent. In another embodiment, the flavoring agent comprises natural vanilla flavor, natural vanilla with other natural flavors, cream flavoring, chocolate flavoring, coffee flavoring, maple flavoring, spice flavoring, mint flavoring, butter flavoring, caramel flavoring, fruit flavoring, or a combination thereof. In another embodiment, the oat milk has a dry solids content from about 0.8 wt % to about 4.2 wt %. In another embodiment, the oat milk has a water content from about 30 wt % to about 60 wt %. In another embodiment, the emulsion is an oil-in-water emulsion. In another embodiment, the whippable topping emulsion does not comprise milk, eggs, fish, shellfish, tree nuts, peanuts, wheat, or soybeans. In another embodiment, the plant-based milk is oat milk, coconut milk, hemp milk, rice milk, pea milk, flax milk, sunflower milk, banana milk, quinoa milk, sesame milk, almond milk, cashew milk, macadamia nut milk, hazelnut milk, walnut milk, peanut milk, or a combination thereof.

Another aspect of the disclosure provides a method for preparing a whipped topping, the method comprising whipping the whippable topping emulsion as described herein. In an embodiment, the method comprises whipping the whippable topping emulsion in a continuous mixer.

Another aspect of the disclosure provides a method of making a whippable topping emulsion comprising: (a) mixing a plant-based milk, vegetable oil, surfactant, thickener, stabilizer, and one or more other components comprising sweeteners and flavoring agents to form a mixture; (b) heating the mixture to about 155° F. to about 175° F.; (c) transferring the mixture to a homogenizer; (d) homogenizing the mixture in two stages, the first stage comprising homogenizing the mixture at a pressure of about 3,000 psi to about 7,000 psi and the second stage comprising homogenizing the mixture at a pressure of about 200 psi to about 600 psi, to form an emulsion; and; (e) cooling the emulsion in two stages, the first stage comprising cooling the emulsion to about 80° F. to about 130° F. and the second stage comprising cooling the emulsion to about 36° F. to about 50° F.; (f) transferring the cooled emulsion to a temperature-controlled tank; (g) tempering the cooled emulsion for at least 4 hours at about 36° F. to about 50° F. In an embodiment, the method further comprises transferring the emulsion of step (g) to a continuous mixer and whipping the emulsion to form a whipped topping. In another embodiment, the whipped topping is packaged and frozen. In another embodiment, the whipped topping has an overrun of from about 200% to 350%. In another embodiment, the emulsion has a median droplet size from about 0.8 microns to about 1.2 microns. In another embodiment, the whipped topping has a shelf life of at least 365 days when frozen. In another embodiment, the whippable topping emulsion does not comprise milk, eggs, fish, shellfish, tree nuts, peanuts, wheat, or soybeans.

Another aspect of the disclosure provides a food product comprising the whipped topping as described herein. In an embodiment, the food product comprises cakes, cupcakes, pies, cookies, beverages, ice cream, puddings, mousse, fruits, and scones.

The disclosure provides for other aspects and embodiments that will be apparent in light of the following detailed description.

### DETAILED DESCRIPTION

Described herein are plant-based whippable emulsions comprising plant-based milk, vegetable oil, and one or more other components such as surfactants, sugar, stabilizers, thickeners, and flavoring. Also disclosed herein are methods of making and methods of using the plant-based milk whippable topping emulsions.

### 1. DEFINITIONS

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and,” and “the” include plural references unless the context clearly dictates otherwise. The present disclosure also contemplates other embodiments “comprising,” “consisting of,” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9; for the range from 6 to 9, the numbers 7 and 8 are contemplated in addition to 6 and 9; and for the range 6.0-7.0, the number 6.0, 6.1, 6.2, 6.3, 6.4, 6.5, 6.6, 6.7, 6.8, 6.9, and 7.0 are explicitly contemplated.

The term “about” or “approximately” as used herein as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In certain aspects, the term “about” refers to a range of values that fall within 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value). Alternatively, “about” can mean within 3 or more than 3 standard deviations, per the practice in the art. Alternatively, such as with respect to biological systems or processes, the term “about” can mean within an order of magnitude, preferably within 5-fold, and more preferably within 2-fold, of a value.

“Allergen” as used herein refers to food allergens, in particular the eight most common food allergens known as the “big 8 allergens” that are milk, eggs, fish, shellfish, tree nuts, peanuts, wheat, and soybeans. A food allergen triggers an immune system reaction soon after ingestion of the food allergen that may result in symptoms such as digestive problems, hives, tingling, swollen airways, or anaphylaxis.

“Allergen-free” as used herein refers to compositions or emulsions that do not comprise any of the big 8 allergens.

“Dairy-free” as used herein refers to a compositions or emulsions that do not comprise milk from an animal such as a cow, yogurt, cheese, lactose-free milk, cream, butter, and the like. “Milk” or “dairy milk” as used herein refers to milk from an animal such as a cow.

“Plant-based milk” as used herein refers to a plant beverage with a color resembling that of dairy milk. Plant-based milks are non-dairy beverages made from a water-based plant extract for flavoring and aroma. Plant-based milks that may be used in an emulsion as described herein include oat milk, coconut milk, hemp milk, rice milk, pea milk, flax milk, sunflower milk, banana milk, quinoa milk, and sesame milk. The plant-based milk may also be soy milk or a nut milk such as almond milk, cashew milk, macadamia nut milk, hazelnut milk, walnut milk, and peanut milk.

Unless otherwise defined herein, scientific and technical terms used in connection with the present disclosure shall have the meanings that are commonly understood by those of ordinary skill in the art. For example, any nomenclatures used in connection with, and techniques of, food science, microbiology, biochemistry, and chemistry described herein are those that are well known and commonly used in the art. The meaning and scope of the terms should be clear; in the event however of any latent ambiguity, definitions provided herein take precedent over any dictionary or extrinsic definition. Further, unless otherwise required by context, singular terms shall include pluralities and plural terms shall include the singular.

### 2. PLANT-BASED WHIPPABLE EMULSION

Provided herein are plant-based whippable emulsions comprising a plant-based milk, a vegetable oil, a surfactant, a thickener, a stabilizer, sweeteners, and flavoring agents. In some embodiments the plant-based whippable emulsion may comprise oat milk. The plant-based whippable emulsions as described herein do not include milk, eggs, fish, shellfish, tree nuts, peanuts, wheat, or soybeans. The plant-based whippable emulsion preferably is free of trans fat, cholesterol, sodium, hydrogenated oils, high fructose corn syrup, corn syrup, modified ingredients, artificial colors, and artificial flavors. The plant-based whippable emulsion as described herein may be an oil-in-water emulsion.

a. Plant-Based Products

Plant-based products, such as plant-based milks, are rich in vitamins and minerals, low in fat, do not contain cholesterol, and have monounsaturated and polyunsaturated fats. Plant-based milks can be creamier, thicker, and have a different taste (e.g., sweet taste) as compared to milk.

A plant-based milk comprised by an emulsion as described herein may be oat milk, coconut milk, hemp milk, rice milk, pea milk, flax milk, sunflower milk, banana milk, quinoa milk, sesame milk, or a combination thereof. In an embodiment, the plant-based milk may be oat milk. In some embodiments, the majority of an emulsion as described herein may be made up of a plant-based milk. An emulsion as described herein may comprise from about 5 wt % to about 50 wt %, from about 5 wt % to about 45 wt %, from about 5 wt % to about 40 wt %, from about 5 wt % to about 35 wt %, from about 5 wt % to about 30 wt %, from about 10 wt % to about 50 wt %, from about 10 wt % to about 45 wt %, from about 10 wt % to about 40 wt %, from about 10 wt % to about 35 wt %, from about 10 wt % to about 30 wt %, from about 20 wt % to about 50 wt %, from about 20 wt % to about 45 wt %, from about 20 wt % to about 40 wt %, from about 20 wt % to about 35 wt %, from about 20 wt % to about 30 wt %, from about 30 wt % to about 50 wt %, from about 30 wt % to about 45 wt %, from about 30 wt % to about 40 wt %, or from about 30 wt % to about 35 wt % of a plant-based milk. In an embodiment, an emulsion as described herein may comprise from about 10 wt % to about 50 wt % of a plant-based milk. In another embodiment, an emulsion as described herein may comprise from about 20 wt % to about 45 wt % of a plant-based milk.

The plant-based milk may have a water content from about 20 wt % to about 98 wt %, from about 25 wt % to about 98 wt %, from about 30 wt % to about 98 wt %, from about 40 wt % to about 98 wt %, from about 50 wt % to about 98 wt %, from about 20 wt % to about 90 wt %, from about 25 wt % to about 90 wt %, from about 30 wt % to about 90 wt %, from about 40 wt % to about 90 wt %, from about 50 wt % to about 90 wt %, from about 20 wt % to about 80 wt %, from about 25 wt % to about 80 wt %, from about 30 wt % to about 80 wt %, from about 40 wt % to about 80 wt %, from about 50 wt % to about 80 wt %, from about 20 wt % to about 70 wt %, from about 25 wt % to about 70 wt %, from about 30 wt % to about 70 wt %, from about 40 wt % to about 70 wt %, from about 50 wt % to about 70 wt %, from about 20 wt % to about 60 wt %, from about 25 wt % to about 60 wt %, from about 30 wt % to about 60 wt %, from about 40 wt % to about 60 wt %, or from about 50 wt % to about 60 wt %. In some embodiments, the plant-based milk may have a water content from about 30 wt % to about 60 wt %.

The plant-based milk may have a dry solids content from about 0.1 wt % to about 10.0 wt %, from about 0.5 wt % to about 10.0 wt %, from about 0.8 wt % to about 10.0 wt %, from about 0.1 wt % to about 5.0 wt %, from about 0.5 wt % to about 5.0 wt %, from about 0.8 wt % to about 5.0 wt %, from about 0.1 wt % to about 4.2 wt %, from about 0.5 wt % to about 4.2 wt %, from about 0.8 wt % to about 4.2 wt %, from about 1.0 wt % to about 4.2 wt %, from about 1.5 wt % to about 4.2 wt %, from about 2.0 wt % to about 4.2 wt %, from about 0.8 wt % to about 3.5 wt %, from about 0.8 wt % to about 3.0 wt %, from about 0.8 wt % to about 2.5 wt %, or from about 0.8 wt % to about 2.0 wt %. In some embodiments, the plant-based milk may have a dry solids content from about 0.8 wt % to about 4.2 wt %.

b. Vegetable Oils

Vegetable oils provide an emulsion as described herein with stability and contribute to the emulsion's whippability. Fat globules contribute to forming stable air bubbles and during whipping, partially coalesced fat molecules create a stabilized network that traps air bubbles. Various types of vegetable oils can be used in the emulsions described herein, including palm kernel oil, coconut oil, palm oil, cottonseed oil, soy oil, sunflower oil, olive oil, corn oil, canola oil, rapeseed oil, safflower oil, sesame oil, and the like, and combinations thereof.

The plant-based whippable emulsion may comprise from about 10 to about 40 wt %, from about 10 to about 35 wt %, from about 10 to about 30 wt %, from about 10 to about 25 wt %, from about 10 to about 20 wt %, from about 15 to about 40 wt %, from about 15 to about 35 wt %, from about 15 to about 30 wt %, from about 15 to about 25 wt %, from about 15 to about 20 wt %, from about 20 to about 40 wt %, from about 20 to about 35 wt %, from about 20 to about 30 wt %, from about 20 to about 25 wt %, from about 25 to about 40 wt %, or from about 30 to about 40 wt % of a vegetable oil. In an embodiment, the plant-based whippable emulsion may comprise from about 15 wt % to about 30 wt % of a vegetable oil.

c. Surfactants

Surfactants are useful in the emulsions disclosed herein. The surfactant may function to form very small particles in the emulsions. The affinity of a surfactant for water and oil is defined by its hydrophilic-lipophilic balance (HLB). Surfactants that may be used have HLB values greater than 8, greater than 9, greater than 10, greater than 11, or greater than 12. Surfactants that may be used have HLB values from about 8 to about 16, from about 9 to about 18, or from about 9 to about 16. Too low of an HLB value will decrease emulsion stability and negatively impact whipping properties of the emulsion. For example, an HLB value of less than 8 is too low.

A blend of surfactants with differing HLB values may be used in the emulsions described herein. When surfactants of differing HLB values are used, the final HLB value is an average of the differing HLB values. For example, a blend of 50 wt % of a surfactant with an HLB of 9 with 50 wt % of a surfactant that has an HLB of 12 will produce a blend with an HLB of 10.5.

A plant-based whippable emulsion as described herein may comprise from about 0.01 wt % to about 2.0 wt % of one or more surfactants. For example, the emulsion may comprise from about 0.05 wt % to about 1.5 wt %, from about 0.05 wt % to about 1.0 wt %, from about 0.05 wt % to about 0.5 wt %, from about 0.1 wt % to about 2.0 wt %, from about 0.1 wt % to about 1.5 wt %, or from about 0.1 wt % to about 1.0 wt % of one or more surfactants. In an embodiment, the plant-based whippable emulsion may comprise from about 0.05 wt % to about 0.55 wt % of one or more surfactants.

In some embodiments, the surfactant as described herein may be an emulsifier.

i) Emulsifiers

Suitable food grade emulsifiers may be used in the herein described compositions. Such emulsifiers include lecithin, hydroxylated lecithin; mono-, di-, or polyglycerides of fatty acids, such as stearin and palmitin mono- and diglycerides, polyoxyethylene ethers of fatty esters of polyhydric alcohols, “Tweens” such as the polyoxyethylene ethers of sorbitan monostearate (polysorbate 60), polysorbate 80, or the polyoxyethylene ethers of sorbitan distearate; fatty esters of polyhydric alcohols such as sorbitan monostearate; “Spans” (sorbitan esters) such as sorbitan monooleate (e.g., Glycomul® O KFG); mono- and diglyceride ethoxylates; glycerol esters, polyglycerol esters of mono- and diglycerides such as hexaglyceryl distearate; mono- and diesters of glycols such as propylene glycol monostearate, and propylene glycol monopalmitate, succinoylated monoglycerides; and the esters of carboxylic acids such as lactic, citric, and tartaric acids with the mono- and diglycerides of fatty acids such as glycerol lacto palmitate and glycerol lacto stearate, and calcium or sodium stearoyl lactylates and all members of the sucrose ester family thereof, all varieties of diacetyltartaric esters of fatty acids, “DATEMS”, dipotassium hydrogen phosphate (DPHP), and mixtures thereof. Preferably sucrose fatty acid esters may be used. Sodium stearoyl lactylate (SSL), DATEMS, or combinations thereof may also be used.

d. Thickeners

A plant-based whippable emulsion as described herein may comprise thickeners. Thickeners increase the viscosity of the aqueous phase of the emulsions described herein and control syneresis of the emulsion when whipped. Thickeners may be soluble or swellable polymers that bind or immobilize water to create structure, stability, and/or viscosity. The thickener may be gellan gum, carobean gum, locus bean gum, cellulose gum, alginate gum, a carbohydrate gum such as agar, guar gum, xanthan gum, gum arabic, and sodium carboxymethyl cellulose, or a combination thereof. Two or more of the foregoing thickeners may be used in an emulsion as described herein to provide complementary effects on control of syneresis, texture, and viscosity of the emulsion. For example, an emulsion may comprise gellan gum, guar gum, and xanthan gum. The gums provide control of syneresis, viscosity, and texture of an emulsion as described herein when whipped. In an embodiment, the plant-based whippable emulsion may comprise from about 0.01 wt % to about 6.0 wt %, from about 0.05 wt % to about 5.0 wt %, typically from about 0.1 wt % to about 3.0 wt %, and more typically from about 0.2 wt % to about 1.0 wt % of a thickener.

e. Stabilizer

A plant-based whippable emulsion as described herein may comprise stabilizers. Stabilizers aid in stability and stiffness of an emulsion as described herein when whipped, such as resulting in rosettes that hold their shape for long periods of time with little to no syneresis. The stabilizer may be cellulose gum, gellan gum, native starches, modified starches, fibers, flours, sodium citrate, or a combination thereof. Two or more of the foregoing stabilizers may be used in an emulsion as described herein to provide complementary effects on control of syneresis, texture, and emulsification of the emulsion. For example, an emulsion may comprise gellan gum, sodium citrate, and cellulose gum. Stabilizers as described herein provide control of syneresis and texture of an emulsion as described herein when whipped and also aid in emulsification. In an embodiment, the plant-based whippable emulsion may comprise from about 0.01 wt % to about 6.0 wt %, typically from about 0.05 wt % to about 5.0 wt %, and more typically from about 0.03 wt % to about 0.2 wt % of a stabilizer.

f. Other Components

A plant-based whippable emulsion as described herein may include sweeteners, flavoring agents, or combinations thereof. Sweeteners may include, but are not limited to, sugar, rice syrup, corn syrup, high fructose corn syrup, tapioca syrup, dextrose, and combinations thereof. In an embodiment, the plant-based whippable emulsion may comprise from about 0 wt % to about 35 wt %, typically from about 0.5 wt % to about 35 wt %, and more typically from about 1 wt % to about 30 wt % of a sweetener.

Flavoring agents may include, but are not limited to, natural vanilla flavoring, natural vanilla with other natural flavors, artificial vanilla flavoring, salt, cream flavoring, chocolate flavoring, coffee flavoring, maple flavoring, spice flavoring, mint flavoring, butter flavoring, caramel flavoring, and fruit flavoring. In an embodiment, the plant-based whippable emulsion may comprise from about 0 wt % to about 5.0 wt %, typically from about 0.001 wt % to about 5.0 wt %, and more typically from about 0.05 wt % to about 3.0 wt % of a flavoring agent.

TABLE 1 provides a non-limiting example of an oat-based whippable emulsion in accordance with the present disclosure.

TABLE 1
Oat-based whippable emulsion example embodiment 1.

| Ingredients | Amount of Ingredient (wt %) |
|---|---|
| Plant-Based Milk | From about 10 to about 50 |
| Vegetable Oil(s) | From about 10 to about 35 |
| Surfactant(s) | From about 0.05 to about 0.55 |
| Thickener(s) | From about 0.02 to about 5.0 |
| Stabilizer(s) | From about 0.02 to about 5.0 |
| Sweetener(s) | From about 1 to about 30 |
| Flavoring Agent | From about 0.05 to about 3.0 |
| Total | 100 |

### 3. METHODS OF MAKING A PLANT-BASED WHIPPABLE EMULSION

Provided herein are methods of making a plant-based whippable topping emulsion as described herein. The methods may include mixing a plant-based milk, vegetable oil, surfactant, thickener, stabilizer, and one or more other components comprising sweeteners and flavoring agents to form a mixture; and heating the mixture to about 155° F. to about 175° F. For example, the mixture may be heated from about 160° F. to about 175° F., from about 165° F. to about 175° F., from about 170° F. to about 175° F., from about 155° F. to about 170° F., from about 155° F. to about 165° F., or from about 155° F. to about 160° F. The mixture may then be transferred to a homogenizer and the mixture may be homogenized in two stages. The mixture may be homogenized via mixing, however, the resulting emulsion is less stable than an emulsion that is homogenized in the homogenizer. In addition, homogenization in the homogenizer allows for generation of the particle size as described herein.

The first stage of homogenization reduces the particle size. The higher the pressure, the smaller the particle size (i.e. median droplet size) within the emulsion. The particle size is also dependent on the type of emulsifier used. The first stage of homogenization may comprise homogenizing the mixture at a pressure of from about 3,000 psi to about 7,000 psi, from about 3,500 psi to about 7,000 psi, from about 4,000 psi to about 7,000 psi, from about 4,500 psi to about 7,000 psi, from about 5,000 psi to about 7,000 psi, from about 5,500 psi to about 7,000 psi, from about 6,000 psi to about 7,000 psi, from about 6,500 psi to about 7,000 psi, from about 3,000 psi to about 6,000 psi, from about 3,500 psi to about 6,000 psi, from about 4,000 psi to about 6,000 psi, from about 4,500 psi to about 6,000 psi, from about 5,000 psi to about 6,000 psi, from about 5,500 psi to about 6,000 psi, from about 3,000 psi to about 5,000 psi, from about 3,500 psi to about 5,000 psi, from about 4,000 psi to about 5,000 psi, from about 4,500 psi to about 5,000 psi, from about 3,000 psi to about 4,000 psi, or from about 3,500 psi to about 4,000 psi.

The second stage of homogenization allows for separation of the particles from the first stage homogenization. For example, there may be agglomeration of the particles with fat after the first stage homogenization. The second stage of homogenization ensures that the fat particles are separated. The homogenization pressure used depends on the level of fat in an emulsion as described herein. The second stage of homogenization may comprise homogenizing the mixture at a pressure of from about 200 psi to about 600 psi, from about 200 psi to about 500 psi, from about 200 psi to about 400 psi, from about 200 psi to about 300 psi, from about 300 psi to about 600 psi, from about 400 psi to about 600 psi, or from about 500 psi to about 600 psi to form an emulsion.

An emulsion prepared by the methods as described herein may have a median droplet size from about 0.5 microns to about 2.0 microns, from about 0.5 microns to about 1.5 microns, from about 0.5 microns to about 1.0 microns, from about 1.0 microns to about 2.0 microns, or from about 1.5 microns to about 2.0 microns. In an embodiment, the emulsion may have a median droplet size from about 0.8 microns to about 1.2 microns.

Following the first and second stages of homogenization, the emulsion may be cooled in two stages. The first stage of cooling initiates fat globule crystallization and the second stage finalizes the fat globule crystallization. The first stage of cooling may comprise cooling the emulsion to from about 80° F. to about 130° F., from about 80° F. to about 120° F., from about 80° F. to about 110° F., from about 80° F. to about 100° F., from about 80° F. to about 90° F., from about 90° F. to about 130° F., from about 100° F. to about 130° F., from about 110° F. to about 130° F., or from about 120° F. to about 130° F. The second stage of cooling may comprise cooling the emulsion to from about 36° F. to about 50° F., from about 40° F. to about 50° F., from about 45° F. to about 50° F., from about 36° F. to about 45° F., or from about 36° F. to about 40° F.

After the emulsion is cooled, the emulsion may be transferred to a temperature-controlled tank. Then, the emulsion may be tempered for at least 6 hours, at least 5 hours, at least 4 hours, at least 3 hours, or at least 2 hours. The emulsion may be tempered at a temperature of from about 36° F. to about 50° F., from about 40° F. to about 50° F., from about 45° F. to about 50° F., from about 36° F. to about 45° F., or from about 36° F. to about 40° F.

Following tempering of the emulsion, the emulsion may be transferred to a continuous mixer and whipped to form a whipped topping. The whipped topping may have an overrun of from about 200% to 500%, from about 200% to 450%, from about 200% to 400%, from about 200% to 350%, from about 200% to 300%, from about 200% to 250%, from about 250% to 500%, from about 300% to 500%, from about 350% to 500%, from about 400% to 500%, or from about 450% to 500%. The whipped topping may be packaged. The whipped topping may be frozen.

The whippable emulsion or whipped emulsion may have a shelf life of at least 10 days, at least 11 days, at least 12 days, at least 13 days, at least 14 days, at least 15 days, or at least 16 days when refrigerated at a temperature of from about 35° F. to about 40° F. The whippable emulsion or whipped emulsion may have a shelf life of at least 365 days, at least 547 days, at least 730 days, at least 912 days, or at least 1,095 days when frozen at a temperature of from about 0° F. to about 15° F., wherein the frozen emulsion is about 19° F.

### 4. METHODS OF USING A PLANT-BASED WHIPPABLE EMULSION

Provided herein are methods of using a plant-based whippable emulsion as described herein. When the emulsion is whipped to form a whipped topping, the whipped topping may be used on a food product. A whipped topping as described herein may be applied to a food product such as cakes, cupcakes, pies, cookies, beverages, ice cream, puddings, mousse, fruits, scones, and the like.

### 5. EXAMPLES

The foregoing may be better understood by reference to the following examples, which are presented for purposes of illustration and are not intended to limit the scope of the invention. The present disclosure has multiple aspects and embodiments, illustrated by the appended non-limiting examples.

### Example 1

### Plant-Based Whippable Emulsion and Whipped Topping Properties

A plant-based whippable emulsion as described herein was prepared by mixing oat milk (oats and water), vegetable oils (palm, palm kernel, coconut and/or cottonseed), sugar, water, rice syrup, and less than 2% of the following: carbohydrate gum, sucrose of the fatty acid esters, natural flavor, gellan gum, sodium citrate, guar gum, and xanthan gum to form a mixture. The mixture was heated to about 155° F. to about 175° F. and transferred to a homogenizer. The mixture was homogenized in two stages to form an emulsion. The first stage homogenization pressure was about 3,000 psi to about 7,000 psi and the second stage homogenization pressure was about 200 psi to about 600 psi. Then, the emulsion was cooled in two stages. The first stage cooled the emulsion to from about 80° F. to about 130° F. and the second stage cooled the emulsion to from about 36° F. to about 50° F. The cooled emulsion was transferred to a temperature-controlled tank and tempered for at least 4 hours at about 36° F. to about 50° F. The tempered emulsion was transferred to a continuous mixer and whipped to form a whipped topping. The whipped topping then was subjected to various analyses to assess the shelf life, performance of the whipped topping (e.g., overrun, rosette time, etc.), fat content, and solids content. The nutrition facts for 2 tablespoons of the whipped topping are shown in TABLE 2.

TABLE 2
Nutrition facts for a 2-tablespoon serving.

| | |
|---|---|
| Total Fat | 3 g |
| Saturated Fat | 3 g |
| Trans Fat | 0 g |
| Cholesterol | 0 mg |
| Sodium | 0 mg |
| Total Carbohydrates | 3 g |
| Dietary Fiber | 0 g |
| Total Sugars | 3 g |
| Protein | 0 g |

The foregoing whipped topping had a shelf life of 350 days when frozen and 14 days when refrigerated. The whipped topping had an overrun of 280% to 300% and a 45-minute rosette time. The total amount of fat in the whipped topping was 25.37% and the total amount of solids was 53.54%.

### Example 2

### Range of Oat Milk Suitable for Use in a Whippable Plant-Based Emulsion

A whipped topping was prepared as described in Example 1, however, the amount of oat milk was varied to analyze its effect on the whipped topping product. Oat milk was chosen as the plant forward ingredient given its many benefits and popularity in the market. It creates a great texture, holds a halo of health for consumers, and can be marketed for its sustainability attributes. To maintain the beneficial properties of oat milk in the final whipped topping, oat milk preferably makes up the largest proportion of the whippable emulsion composition. Several ranges were tested to achieve the best performance as shown in TABLE 3.

TABLE 3
Performance of whippable emulsions comprising
various amounts of oat milk.

| Percentage | | |
|---|---|---|
| of Oat | Pass/ | Performance of Whippable/Whipped |
| Milk | Fail | Composition |
| ≥60% | Fail | Highly viscous, couldn't be processed. |
| 59.2% | Pass | Highly viscous, difficult to process, whipped product |
| | | will dry and harden over time. |
| 55.7% | Pass | Highly viscous, difficult to process, whipped product |
| | | will dry and harden over time. |
| 55.2% | Pass | Highly viscous, difficult to process, whipped product |
| | | will dry and harden over time. |
| 53.3% | Pass | Highly viscous, good processing, whipped product |
| | | will dry and harden over time. |
| 51.7% | Pass | Highly viscous, good processing, whipped product |
| | | will dry and harden over time. |
| 49.8% | Pass | Highly viscous, good processing, whipped product |
| | | will dry and harden over time. |
| 35.5% | Pass | Medium viscosity, easy to process, great mouthfeel |
| | | and body. |
| ≤5% | Fail | Texture was compromised. |

As used in TABLE 3, “pass” and “fail” indicate whether the performance of a composition was acceptable for use. As indicated in TABLE 3, percentages of oat milk at or above 60% are not suitable for use in an emulsion as described herein and resulted in a gelation of the top layer of the liquid composition. Percentages of oat milk at or below 5% are not suitable for use in an emulsion as described herein and would negatively change the viscosity, mouthfeel, and the texture of the whipped product.

### Example 3

### Types of Emulsifies and Stabilizers Suitable for Use in a Whippable Plant-Based Emulsion

Traditionally, whip topping products are oil in water emulsions that contain emulsifiers, protein, and stabilizers. Dairy protein is a major contributor to the stability of an emulsion that acts as a foaming agent, foam stabilizer, and texturizer. Many new plant-based formulas attempt to replicate the same effect of dairy protein by using plant-based proteins, but have not achieved the same performance as dairy protein-based emulsions. The composition as described in Example 1 contains less than 0.35% of oat protein, provided by the oat milk, and does not provide performance functionality like dairy proteins.

Multiple experiments were conducted using emulsifiers, other natural emulsifying agents, and combinations thereof in place of dairy proteins. It was found that the interaction between sucrose fatty acid esters and cellulose gum provided an emulsion as described herein with stability (such as preventing liquid or phase separation), whippability, and foam stability. It was also found that sucrose fatty acid esters and sodium stearyl lactylate (SSL) are interchangeable.

The working range of SSL or sucrose fatty acid esters in the emulsion was from 0.3 wt. % to 0.45 wt. %. Below 0.3 wt. %, the emulsion was not stable. Above 0.45 wt. % the overrun was increased, but the whipped product lacked foam stability. The working range of cellulose gum was 0.1 wt. % to 0.4 wt. %. Below 0.1 wt. %, the emulsion stability was compromised. Above 0.4 wt. % the overrun was increased, but the whipped product lacked foam stability and caused a loss of air over the shelf life. The working ranges of oil in combination with the working ranges of SSL or sucrose fatty acid esters in addition to the working ranges of cellulose gum, provided a stable emulsion, good overrun, and some foam stability. Various emulsifiers were tested, see TABLE 4.

TABLE 4
Performance of whippable emulsions
comprising various emulsifiers.

| | Pass/ | Performance of Whippable/Whipped |
|---|---|---|
| Emulsifier | Fail | Composition |
| Sucrose Fatty Acid | Pass | Very smooth creamy whipped product. |
| Esters | | |
| SSL | Pass | Same performance as sucrose fatty acid |
| | | esters - they can be interchangeable. |
| Sunflower Lecithin | Fail | Very thick liquids. High air cell |
| | | coalescence present over shelf life. |
| Distilled Monoglycerides | Fail | Liquids inverted. |
| Quillaja Extract | Fail | Did not whip, appeared frothy. |

As used in TABLE 4, “pass” and “fail” indicate whether the performance of a composition was acceptable for use.

To strengthen the foam stability of a post freeze/thaw product even further, various stabilizers such as starches, gums, and plant-based proteins were tested. None of the plant-based proteins or starches provided acceptable results—the product texture was modified, but foam stability was not improved. Gellan gum, out of many gums tested, provided unique effects in increasing foam firmness and foam stability (TABLE 5).

TABLE 5
Performance of whippable emulsions comprising various gums.

| | Pass/ | Performance of Whippable/Whipped |
|---|---|---|
| Gum | Fail | Composition |
| Carregeenan | Pass | Increased viscosity, shorten whipping times, |
| (kappa/lambda/ | | foam stability, great mouthfeel, smooth |
| iota type or | | texture. |
| combination of) | | Increased viscosity, shorten whipping times, |
| Alginates | Pass | foam stability, great mouthfeel, smooth |
| | | texture. |
| Locus Bean Gum + | Pass | Great increase in viscosity, longer whipping |
| Xanthan Gum | | times and lower overrun. Foam stability. |
| | | Increased viscosity, shorten whipping times, |
| Gellan Gum | Pass | superior foam stability, mouthfeel and |
| | | smooth texture. |
| Gum Arabic | Fail | Increased viscosity, but did not control |
| | | syneresis, whipped products hardened over |
| | | shelf life. |
| Faba Bean Protein | Fail | Increased viscosity, but did not control |
| | | syneresis, whipped products hardened over |
| | | shelf life. |

As used in TABLE 5, “pass” and “fail” indicate whether the performance of a composition was acceptable for use.

The foregoing description of the specific aspects will so fully reveal the general nature of the invention that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary aspects, but should be defined only in accordance with the following claims and their equivalents.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

For reasons of completeness, various aspects of the invention are set out in the following numbered clauses:

Clause 1. A whippable topping emulsion comprising: (a) plant-based milk; (b) vegetable oil; (c) surfactant; (d) thickener; (e) stabilizer; and, (f) one or more other components comprising sweeteners and flavoring agents.

Clause 2. A whippable topping emulsion comprising: (a) from about 10 wt % to about 50 wt % plant-based milk; (b) from about 10 wt % to about 35 wt % vegetable oil; (c) from about 0.05 wt % to about 0.55 wt % surfactant; (d) from about 0.02 wt % to about 5.0 wt % thickener; (e) from about 0.02 wt % to about 5.0 wt % stabilizer; and, (f) one or more other components comprising sweeteners and flavoring agents.

Clause 3. A whippable topping emulsion comprising: (a) oat milk; (b) vegetable oil; (c) surfactant; (d) thickener; (e) stabilizer; and, (f) one or more other components comprising sweeteners and flavoring agents.

Clause 4. A whippable topping emulsion comprising: (a) from about 10 wt % to about 50 wt % oat milk; (b) from about 10 wt % to about 35 wt % vegetable oil; (c) from about 0.05 wt % to about 0.55 wt % surfactant; (d) from about 0.02 wt % to about 5.0 wt % thickener; (e) from about 0.02 wt % to about 5.0 wt % stabilizer; and, (f) one or more other components comprising sweeteners and flavoring agents.

Clause 5. The whippable topping emulsion of any one of the preceding clauses, wherein the vegetable oil comprises palm kernel oil, coconut oil, palm oil, cottonseed oil, soy oil, or a combination thereof.

Clause 6. The whippable topping emulsion of any one of the preceding clauses, wherein the surfactant is an emulsifier comprising a hydrophilic-lipophilic balance (HLB) value greater than 9.

Clause 7. The whippable topping emulsion of any one of the preceding clauses, wherein the thickener comprises gellan gum, carobean gum, locus bean gum, cellulose gum, alginate gum, agar, guar gum, xanthan gum, gum arabic, sodium carboxymethyl cellulose, or a combination thereof.

Clause 8. The whippable topping emulsion of any one of the preceding clauses, wherein the stabilizer comprises cellulose gum, gellan gum, native starches, modified starches, fibers, flours, sodium citrate, or a combination thereof.

Clause 9. The whippable topping emulsion of any one of the preceding clauses, wherein the whippable topping emulsion comprises from about 1 wt % to about 30 wt % sweetener.

Clause 10. The whippable topping emulsion of clause 9, wherein the sweetener comprises sugar, rice syrup, corn syrup, high fructose corn syrup, tapioca syrup, dextrose, or a combination thereof.

Clause 11. The whippable topping emulsion of any one of the preceding clauses, wherein the whippable topping emulsion comprises from about 0.05 wt % to about 3 wt % of a flavoring agent.

Clause 12. The whippable topping emulsion of clause 11, wherein the flavoring agent comprises natural vanilla flavor, natural vanilla with other natural flavors, cream flavoring, chocolate flavoring, coffee flavoring, maple flavoring, spice flavoring, mint flavoring, butter flavoring, caramel flavoring, fruit flavoring, or a combination thereof.

Clause 13. The whippable topping emulsion of any one of clauses 3-12, wherein the oat milk has a dry solids content from about 0.8 wt % to about 4.2 wt %.

Clause 14. The whippable topping emulsion of any one of clauses 3-13, wherein the oat milk has a water content from about 30 wt % to about 60 wt %.

Clause 15. The whippable topping emulsion of any one of the preceding clauses, wherein the emulsion is an oil-in-water emulsion.

Clause 16. The whippable topping emulsion of any one of the preceding clauses, wherein the whippable topping emulsion does not comprise milk, eggs, fish, shellfish, tree nuts, peanuts, wheat, or soybeans.

Clause 17. The whippable topping emulsion of clause 1 or clause 2, wherein the plant-based milk is oat milk, coconut milk, hemp milk, rice milk, pea milk, flax milk, sunflower milk, banana milk, quinoa milk, sesame milk, almond milk, cashew milk, macadamia nut milk, hazelnut milk, walnut milk, peanut milk, or a combination thereof.

Clause 18. A method for preparing a whipped topping, the method comprising whipping the whippable topping emulsion of any one of the preceding clauses.

Clause 19. The method of clause 18, wherein the method comprises whipping the whippable topping emulsion in a continuous mixer.

Clause 20. A method of making a whippable topping emulsion comprising: (a) mixing a plant-based milk, vegetable oil, surfactant, thickener, stabilizer, and one or more other components comprising sweeteners and flavoring agents to form a mixture; (b) heating the mixture to about 155° F. to about 175° F.; (c) transferring the mixture to a homogenizer; (d) homogenizing the mixture in two stages, the first stage comprising homogenizing the mixture at a pressure of about 3,000 psi to about 7,000 psi and the second stage comprising homogenizing the mixture at a pressure of about 200 psi to about 600 psi, to form an emulsion; and; (e) cooling the emulsion in two stages, the first stage comprising cooling the emulsion to about 80° F. to about 130° F. and the second stage comprising cooling the emulsion to about 36° F. to about 50° F.; (f) transferring the cooled emulsion to a temperature-controlled tank; (g) tempering the cooled emulsion for at least 4 hours at about 36° F. to about 50° F.

Clause 21. The method of clause 20, wherein the method further comprises transferring the emulsion of step (g) to a continuous mixer and whipping the emulsion to form a whipped topping.

Clause 22. The method of clause 21, wherein the whipped topping is packaged and frozen.

Clause 23. The method of clause 21, wherein the whipped topping has an overrun of from about 200% to 350%.

Clause 24. The method of any one of clauses 20-23, wherein the emulsion has a median droplet size from about 0.8 microns to about 1.2 microns.

Clause 25. The method of any one of clauses 20-24, wherein the whipped topping has a shelf life of at least 365 days when frozen.

Clause 26. A food product comprising the whipped topping of any one of clauses 18, 21-23.

Clause 27. The method of clause 26, wherein the food product comprises cakes, cupcakes, pies, cookies, beverages, ice cream, puddings, mousse, fruits, and scones.

Clause 28. The method of clause 20, wherein the whippable topping emulsion does not comprise milk, eggs, fish, shellfish, tree nuts, peanuts, wheat, or soybeans.

What is claimed is:

1. A whippable topping emulsion comprising:
(a) plant-based milk;
(b) vegetable oil;
(c) surfactant;
(d) thickener;
(e) stabilizer; and,
(f) one or more other components comprising sweeteners and flavoring agents.

2. A whippable topping emulsion comprising:
(a) from about 10 wt % to about 50 wt % plant-based milk;
(b) from about 10 wt % to about 35 wt % vegetable oil;
(c) from about 0.05 wt % to about 0.55 wt % surfactant;
(d) from about 0.02 wt % to about 5.0 wt % thickener;
(e) from about 0.02 wt % to about 5.0 wt % stabilizer; and,
(f) one or more other components comprising sweeteners and flavoring agents.

3. A whippable topping emulsion comprising:
(a) oat milk;
(b) vegetable oil;
(c) surfactant;
(d) thickener;
(e) stabilizer; and,
(f) one or more other components comprising sweeteners and flavoring agents.

4. A whippable topping emulsion comprising:
(a) from about 10 wt % to about 50 wt % oat milk;
(b) from about 10 wt % to about 35 wt % vegetable oil;
(c) from about 0.05 wt % to about 0.55 wt % surfactant;
(d) from about 0.02 wt % to about 5.0 wt % thickener;
(e) from about 0.02 wt % to about 5.0 wt % stabilizer; and,
(f) one or more other components comprising sweeteners and flavoring agents.

5. The whippable topping emulsion of claim 1, wherein the vegetable oil comprises palm kernel oil, coconut oil, palm oil, cottonseed oil, soy oil, or a combination thereof.

6. The whippable topping emulsion of claim 1, wherein the surfactant is an emulsifier comprising a hydrophilic-lipophilic balance (HLB) value greater than 9.

7. The whippable topping emulsion of claim 1, wherein the thickener comprises gellan gum, carobean gum, locus bean gum, cellulose gum, alginate gum, agar, guar gum, xanthan gum, gum arabic, sodium carboxymethyl cellulose, or a combination thereof.

8. The whippable topping emulsion of claim 1, wherein the stabilizer comprises cellulose gum, gellan gum, native starches, modified starches, fibers, flours, sodium citrate, or a combination thereof.

9. The whippable topping emulsion of claim 1, wherein the whippable topping emulsion comprises from about 1 wt % to about 30 wt % sweetener.

10. The whippable topping emulsion of claim 9, wherein the sweetener comprises sugar, rice syrup, corn syrup, high fructose corn syrup, tapioca syrup, dextrose, or a combination thereof.

11. The whippable topping emulsion of claim 1, wherein the whippable topping emulsion comprises from about 0.05 wt % to about 3 wt % of a flavoring agent.

12. The whippable topping emulsion of claim 11, wherein the flavoring agent comprises natural vanilla flavor, natural vanilla with other natural flavors, cream flavoring, chocolate flavoring, coffee flavoring, maple flavoring, spice flavoring, mint flavoring, butter flavoring, caramel flavoring, fruit flavoring, or a combination thereof.

13. The whippable topping emulsion of claim 3, wherein the oat milk has a dry solids content from about 0.8 wt % to about 4.2 wt %.

14. The whippable topping emulsion of claim 3, wherein the oat milk has a water content from about 30 wt % to about 60 wt %.

15. The whippable topping emulsion of claim 1, wherein the emulsion is an oil-in-water emulsion.

16. The whippable topping emulsion of claim 1, wherein the whippable topping emulsion does not comprise milk, eggs, fish, shellfish, tree nuts, peanuts, wheat, or soybeans.

17. The whippable topping emulsion of claim 1, wherein the plant-based milk is oat milk, coconut milk, hemp milk, rice milk, pea milk, flax milk, sunflower milk, banana milk, quinoa milk, sesame milk, almond milk, cashew milk, macadamia nut milk, hazelnut milk, walnut milk, peanut milk, or a combination thereof.

18. A method for preparing a whipped topping, the method comprising whipping the whippable topping emulsion of claim 1.

19. The method of claim 18, wherein the method comprises whipping the whippable topping emulsion in a continuous mixer.

20. A method of making a whippable topping emulsion comprising:
(a) mixing a plant-based milk, vegetable oil, surfactant, thickener, stabilizer, and one or more other components comprising sweeteners and flavoring agents to form a mixture;
(b) heating the mixture to about 155° F. to about 175° F.;
(c) transferring the mixture to a homogenizer;
(d) homogenizing the mixture in two stages, the first stage comprising homogenizing the mixture at a pressure of about 3,000 psi to about 7,000 psi and the second stage comprising homogenizing the mixture at a pressure of about 200 psi to about 600 psi, to form an emulsion; and;
(e) cooling the emulsion in two stages, the first stage comprising cooling the emulsion to about 80° F. to about 130° F. and the second stage comprising cooling the emulsion to about 36° F. to about 50° F.;
(f) transferring the cooled emulsion to a temperature-controlled tank;
(g) tempering the cooled emulsion for at least 4 hours at about 36° F. to about 50° F.

21. The method of claim 20, wherein the method further comprises transferring the emulsion of step (g) to a continuous mixer and whipping the emulsion to form a whipped topping.

22. The method of claim 21, wherein the whipped topping is packaged and frozen.

23. The method of claim 21, wherein the whipped topping has an overrun of from about 200% to 350%.

24. The method of claim 20, wherein the emulsion has a median droplet size from about 0.8 microns to about 1.2 microns.

25. The method of claim 20, wherein the whipped topping has a shelf life of at least 365 days when frozen.

26. A food product comprising the whipped topping of claim 21.

27. The method of claim 26, wherein the food product comprises cakes, cupcakes, pies, cookies, beverages, ice cream, puddings, mousse, fruits, and scones.

28. The method of claim 20, wherein the whippable topping emulsion does not comprise milk, eggs, fish, shellfish, tree nuts, peanuts, wheat, or soybeans.
